(19) United States
(12) Patent Application Publication
(10) Pub. No.: US 2008/0130667 A1
(43) Pub. Date: Jun. 5, 2008

(54) DISTRIBUTED ARBITRATION MECHANISM FOR RING NETWORKS

(75) Inventors: Brian M. Bass, Apex, NC (US); Timothy H. Heil, Rochester, MN (US); Michael S. Siegel, Raleigh, NC (US); Jeffrey R. Summers, Raleigh, NC (US); Tiffany Tamaddoni-Jahromi, Raleigh, NC (US); Steven P. VanderWiel, Rosemount, MN (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/564,863

(22) Filed: Nov. 30, 2006

(51) Int. Cl. H04L 12/66

(52) U.S. Cl. 370/403

(57) ABSTRACT

A system for employing a scalable distributed arbitration scheme, including: a plurality of stations interconnected via a ring topology for transferring data between the plurality of stations; and a bus coupling the plurality of stations in the ring topology; wherein each of the plurality of stations on the topology ring is permitted to independently make a decision when to load their data on the topology ring by evaluating a set of inputs.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data transfer systems, and particularly to a distributed arbitration mechanism for ring networks.

2. Description of Background

A ring network is a topology of computer networks (or computer stations) where each node is connected to two other nodes, so as to create a ring. Ring networks employ an arbitration phase during which all nodes seeking access to a bus send arbitration requests to the root node. The root node then resolves the arbitration and grants the bus to one of the arbitration nodes. Traditional arbitration schemes use centralized arbitration to determine when each computer station can load data on the ring. In such centralized arbitration schemes, all stations sending data make a request to an arbitration block, and wait for a grant back from the arbitration block before sending their data. However, there are a number of drawbacks to this methodology.

The first issue involves delays, and, specifically, there is a delay between making the request and receiving the grant in traditional arbitration schemes. This delay can cause data to back up at the station, as well as inefficiencies in the ring utilization, as usable cycles are missed waiting for a grant. The length of the delay depends on the distance to the arbitration logic and the complexity of the arbitration logic. One common means of counteracting that delay is to arbitrate for the right to send data on multiple consecutive cycles, or beats. However, this tends to make the arbitration logic more complex as it is required to find larger openings on the ring for each station to send the multiple beats. The added complexity can wrap back into longer delays between requests and grants.

Secondly, another issue involves a tradeoff that is made between efficient use of the ring and complexity of the central arbitration logic. To fully utilize the ring the central arbitration logic knows where all data currently is on the ring and which station is entitled to remove that data. The central arbitration logic also looks at all outstanding requests and, with this information, sends grants to all stations that can send data. Ideally this is performed in a single cycle, which even for systems with mediocre performance and more than a couple of stations is very difficult. Higher performance systems with a number of stations require multiple cycles to return a grant. This delay, as mentioned earlier, means arbitration decisions cannot be made with all the latest requests, which can waste usable ring cycles.

Thirdly, the central arbitration block is designed for a set number of computer stations on the ring. Since the logic looks at all outstanding ring traffic and requests at once, scalability is difficult to achieve; the problem grows with the square of the number of requesters. The addition or removal of even a single station means the entire central arbitration block will require extensive redesign. While some distributed arbitration schemes exist, they do not fully distribute arbitration decisions to individual stations. Some distributed arbitration schemes, such as token ring, require a station to have a token before they can load data on the ring. This method eliminates the complicated arbitration logic of a central arbitration scheme, but does so by limiting ring usage to a single transmitter. Other schemes have multiple arbitration blocks that make decisions for local stations, but still require those decisions to be passed to the other arbitration blocks or a central arbitration hub before a final arbitration decision is reached.

Considering the limitations of the aforementioned methods, it is clear that there is a need for a scalable distributed arbitration scheme for a ring topology that simplifies the required arbitration logic, while providing efficient utilization of the available ring bandwidth by allowing multiple non-colliding transfers to occur simultaneously.

### SUMMARY OF THE INVENTION

The shortcomings of the prior art are overcome and additional advantages are provided through the provision of a system for employing a scalable distributed arbitration scheme, the system comprising: a plurality of stations interconnected via a ring topology for transferring data between the plurality of stations; and a bus coupling the plurality of stations in the ring topology; wherein each of the plurality of stations on the topology ring is permitted to independently make a decision when to load the data on the topology ring by evaluating a set of inputs.

The shortcomings of the prior art are overcome and additional advantages are provided through the provision of a method having a plurality of stations interconnected via a ring topology for passing data between the plurality of stations by a scalable distributed arbitration scheme, the method comprising: interconnecting a plurality of stations via a ring topology for transferring data between the plurality of stations; and coupling the plurality of stations in the ring topology via a bus; wherein each of the plurality of stations on the topology ring is permitted to independently make a decision when to load the data on the topology ring by evaluating a set of inputs.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a scalable distributed arbitration scheme for a ring topology that simplifies the required arbitration logic, while providing efficient utilization of the available ring bandwidth by allowing multiple non-colliding transfers to occur simultaneously.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates examples of the operation of cases where arbitration is for two beat arbitration blocks and allows for the arbitration cycle to be on any cycle; and

FIG. 2 illustrates examples of operation of cases where arbitration is for two beat arbitration blocks and restricts arbitration to fixed cycles; and

FIG. 3 illustrates an example of the winner flag initialization and values in successive cycles using a four-state winner flag for a ring network with the number of stations being an even multiple of four (eight in this case); and

FIG. 4 illustrates an example of the winner flag initialization and values in successive cycles using a four-state winner flag for a ring network with the number of stations not being an integer multiple of four (six in this case); and

FIG. 5 illustrates an example of the winner flag initialization and values in successive cycles using an eighteen-state winner flag for a ring network with the number of stations not being an integer multiple of four (six in this case); and

### DETAILED DESCRIPTION OF THE INVENTION

One aspect of the exemplary embodiments is a system having a scalable distributed arbitration scheme for a ring topology that simplifies the required arbitration logic, while providing efficient utilization of the available ring bandwidth by allowing multiple non-colliding transfers to occur simultaneously. In another aspect of the exemplary embodiments, a distributed arbitration scheme for passing data between stations in a system using such stations on a ring interconnection is provided. Data received from the previous station is removed from the ring when it has reached its destination. Otherwise, it is passed to the next station on the ring in the next cycle. Each station is able to place its station's data on the ring when it has won the right to do so. Passing data received from the previous station through to the next station has priority over placing the station's data on the ring.

Therefore, in the exemplary embodiments of the present invention, rather than using a central arbitration block, each station is responsible for determining whether it can send data out on the ring by looking at incoming data valids and signals indicating intent to send data from neighboring stations. A “winner flag” is used to keep a station from locking out its downstream station by continually placing data on the ring. This distributed arbitration method greatly reduces the logic needed to make arbitration decisions, while making it scalable by simply adding or removing stations on the ring. It eliminates the delays in arbitration decisions that hinder central arbitration and some distributed arbitration schemes, thus allowing more efficient use of the ring bandwidth. It also eliminates the inefficiencies in some distributed and centralized schemes by allowing multiple non-colliding transfers to occur simultaneously.

The distributed arbitration scheme of the exemplary embodiments allows each station on the ring to decide independently whether to load its data on the ring. Each station has the same internal logic and examines the same set of inputs for performing this arbitration, which allows easy scalability by simply inserting or removing a station anywhere on the ring. That set of inputs is restricted to a small number of outputs from neighboring stations, thus eliminating the need for knowledge of the complete system required in central arbitration schemes.

Each station looks at incoming traffic from upstream stations to determine if their data is required to be passed through, or if there is an opening (referred to as an arbitration block) in which to send its own data. In the cycle before sending its own data (referred to as the arbitration cycle), though, a station independently makes its own arbitration decision based on whether neighboring stations also wish to use that arbitration block. If neighboring stations signal that they want to send their own data by asserting intent, the station's decision is made based on its winner flag state held by the station. Winner flag state can be passed between stations or can be tracked internally by each station, but cannot be in the “winner” state for neighboring stations at the same time. They should also cycle (change between a “winner” and “loser” state) so that each station has an equal number of opportunities to claim use of incoming arbitration blocks.

The exemplary embodiments of the present invention assume all data transfers have been broken into two-beat transfers. However, someone skilled in the art would be able to extend this implementation to both larger transfers and to single-beat transfers.

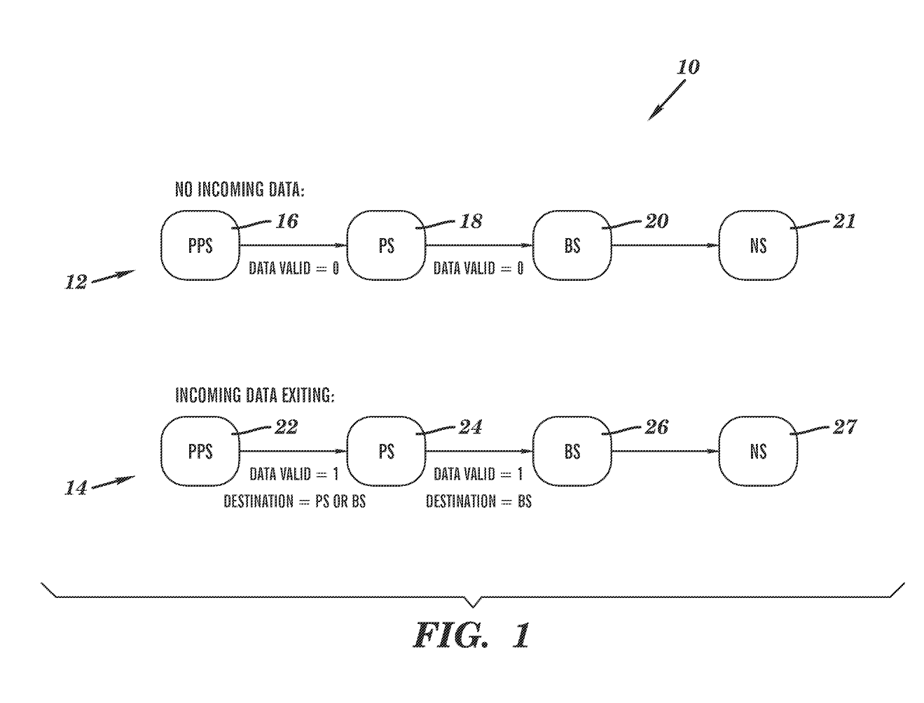

Referring to FIG. 1, two examples of operation 10 are shown. In each example, 12 and 14, 3 stations of a ring are shown. The examples are taken from the view of the base station (BS) 20 or 26. The direction that data travels is shown by the direction of the arrows. The upstream direction is opposite the direction of the data flow. The first station upstream from BS is referred to as the previous station (PS) 18 or 24. The second station upstream from the BS is referred to as the previous-previous station (PPS) 16 or 22. The downstream direction is the same as the direction of the dataflow. The first station downstream from BS is referred to as the next station (NS) 21 or 27. In these examples, the BS is looking for a 2 cycle opening or arbitration block that is either not in use by another station, or will be available to BS because the data has exited the ring either prior to arriving at BS or exiting at BS. BS is allowed to examine input signals data valid and intent on any cycle. The examination cycle is also referred to as the arbitration cycle. If during an arbitration cycle it is determined that data can be moved onto the ring, the data appears on the ring at the output of BS one cycle after the arbitration cycle.

In example 12, illustrating an arbitration cycle, a station on the ring (referred to as a base station, or BS 20) looks at the data valid signals being sent by the station upstream from it (referred to as a previous station, or PS 18) and the station upstream from PS (referred to as a previous-previous station, or PPS 16). If both data valid signals are inactive, then a two-beat arbitration block may be available to BS 20. BS 20 must then examine its winner flag state and the intent signals from PS 18 and NS 21. If BS's winner flag state is “winner” then BS 20 may use the arbitration block. If BS's winner flag state is “loser”, then BS may use the arbitration block only if PS 18 and NS 21 intent signals are both de-asserted.

In example 14, illustrating an arbitration cycle where data valid is asserted by both PPS 22 and PS 24, the BS 26 must examine the destination information related to the data accompanying the data valid signals being asserted. If the examination reveals that the data being sent by PPS 22 will exit at either PS 24 or BS 26 and the data being sent by PS 24 will exit at BS 26, then an arbitration block may be available for use by BS 26. BS 26 then must examine its winner flag state and the intent signals from PS 24 and NS 27. If BS's winner flag state is “winner” then BS 26 may use the arbitration block. If BS's winner flag state is “loser”, then BS 26 may use the arbitration block only if PS 24 and NS 27 intent signals are both de-asserted. It is a requirement that two neighboring stations cannot both have a winner flag state of “winner”. In this embodiment, each station has a winner flag state of winner for two cycles, then goes at least two cycles in the loser state. The ring is initialized so that every other station starts with a winner flag in the winner state. For rings with an odd number of stations, the extra station is initialized with the winner flag state set to loser to insure no two neighboring stations ever have a winner flag at the same time. Winner flags can be passed between stations or can be tracked internally by each station.

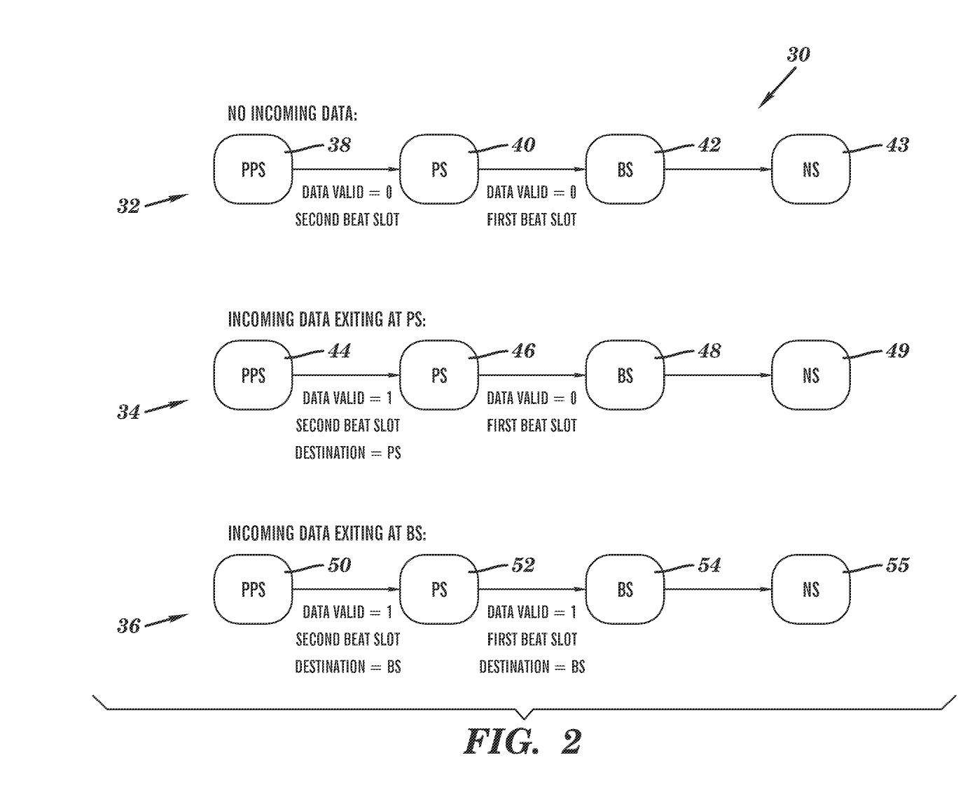

Referring to FIG. 2, 3 examples of operation 30 are shown where the arbitration cycle is restricted to fixed slots on the ring. Neighboring stations do not arbitrate in the same cycle. This embodiment is restricted to even station count rings and two beat arbitration blocks. Dummy stations which do not insert data on the ring, can be added to an odd station count ring to make it even. This simplifies the approach described above and illustrated in FIG. 1 by eliminating signaling between PPS 38 or 44 or 50 and BS 42 or 48 or 54 and insures that empty one cycle slots between 2-cycle arbitration blocks containing data cannot be created. Example 32 shows BS' 42 arbitration cycle where data valid from PPS 38 and PS 40 are both de-asserted. Example 34 shows BS' 48 arbitration cycle where data valid is asserted only by PPS 44. Note that since the arbitration and thus the cycles where data can be placed on the bus are fixed, that this condition occurs only if the arbitration block leaving PPS 44 exits at PS 46. Example 36 shows BS' 54 arbitration cycle where data valid is asserted for both PS 52 and PPS 50. Note that since the arbitration and thus the cycles where data can be placed on the bus are fixed, the arbitration block leaving PPS 50 and PS 52 must be destined for either BS or a station beyond BS. In example 50, the data is destined for BS 54.

In example 32, PS 40 and PPS 38 have data valid de-asserted. During BS' 42 arbitration cycle, BS first examines data valid from PS and finds that it is de-asserted. PS' intent is not examined. If PS had intent, the data would have been on the ring during BS' arbitration cycle. BS must then examine its winner flag state. If BS' winner flag state is winner, then BS can use the arbitration block. If BS' winner flag state is loser, the NS's intent must be de-asserted to allow BS to use the arbitration block. In example 34, PPS 44 has data valid asserted and PS 46 has data valid de-asserted. During BS' 48 arbitration cycle, BS sees the same conditions as it sees in example 32 and all the same actions occur as described above. This does not lead to any data collisions due to the fact that the arbitration blocks are allowed only in fixed slots (beat 1 and beat 2 of each arbitration block are fixed in each slot of the ring). Since the example shows that the first beat of an arbitration block is exiting PS with data valid de-asserted, it follows that the data must have exited at PS. Further, as in example 32, PS had no intent since the first beat of the arbitration block was unused (data valid is de-asserted). In example 36, data valid is asserted by both PPS 50 and PS 52. During BS' 54 arbitration cycle, only PS' data valid is examined and found to be asserted. Since this first cycle of the arbitration block is in use (data valid asserted), then BS must examine the destination information for the data. In this example, the destination has been found to be BS, thus the arbitration block may be available to BS for use. BS must then examine its winner flag state. If BS' winner flag state is winner, then BS can use the arbitration block. If the winner flag state is loser, the NS's intent must be de-asserted to allow BS to use the arbitration block.

In the distributed arbitration scheme 30 where arbitration is restricted to fixed slots on the ring, each station can track their winner flag and arbitration cycles with a two-bit counter. When the LSB (Least Significant Bit) of the counter is active it indicates that stations turn to arbitrate for use of an incoming open arbitration block. The MSB (Most Significant Bit) is that station's winner flag. Each station is initialized to one of the four possible values, with its downstream station being initialized to the value one greater. If BS 42 or 48 or 54 is initialized to “11” then the value for NS 43 or 49 or 55 wraps to “00”. With each clock cycle every station increments its counter (again, with “11” wrapping to “00”), giving each station the opportunity to arbitrate for ring bandwidth on every other cycle (i.e., its arbitration cycle) and ensuring that it has the winner flag for every other arbitration cycle.

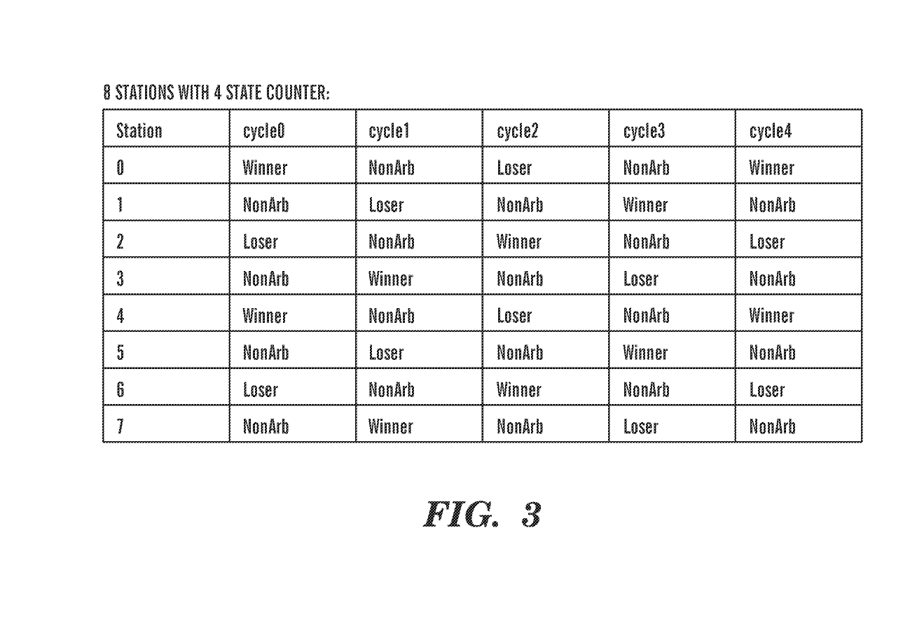

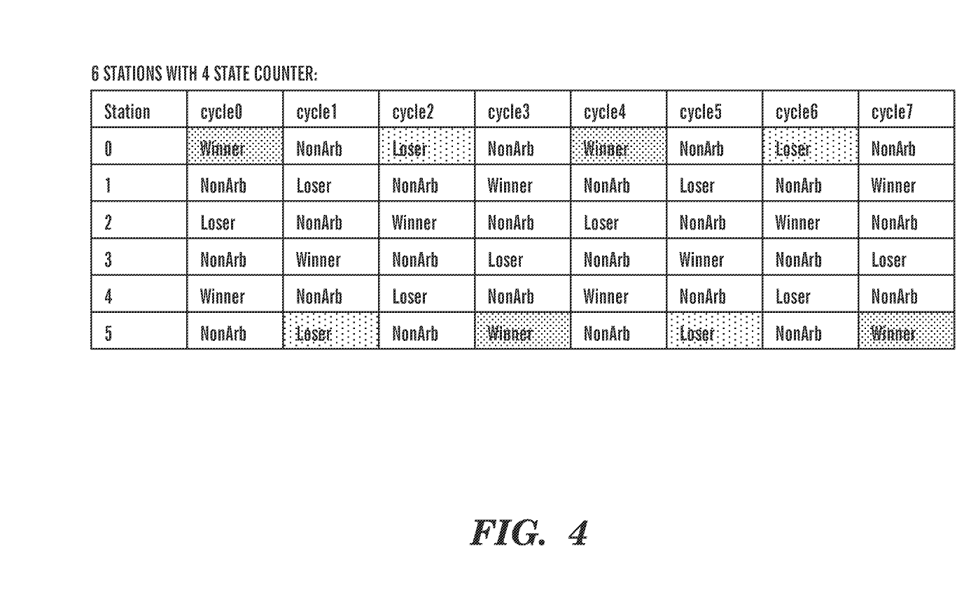

This 2 bit counter scheme produces equal opportunities for all stations when the number of stations in the ring is an integer multiple of 4 (FIG. 3). However, when the number of stations is not an integer multiple of 4, there is a discontinuity in the state distribution around the ring (FIG. 4). This discontinuity causes an unfair advantage at the discontinuity point when neighboring stations have intent to send. Specifically, neither station will send when there are back-to-back Loser-Loser states, and the first station will always send when there are back-to-back Winner-Winner states. FIG. 4 shows an example of a 6 station ring. Consider cycle3 when both station5 and station0 have intent. Station5 is in the winner state, so it will use the arbitration block, preventing station0 from using it during its arbitration cycle, regardless of winner/loser state. Every time station0 is in the winner state, station5 was in the winner state during the previous cycle. This unfairly disadvantages station0. Now consider cycle1 when both station5 and station0 have intent. Station5 is not in the winner state, so must defer to station0. In cycle2, station0 is not in the winner state, therefore, if station1 also has intent, station0 will also defer. This wastes usable arbitration blocks.

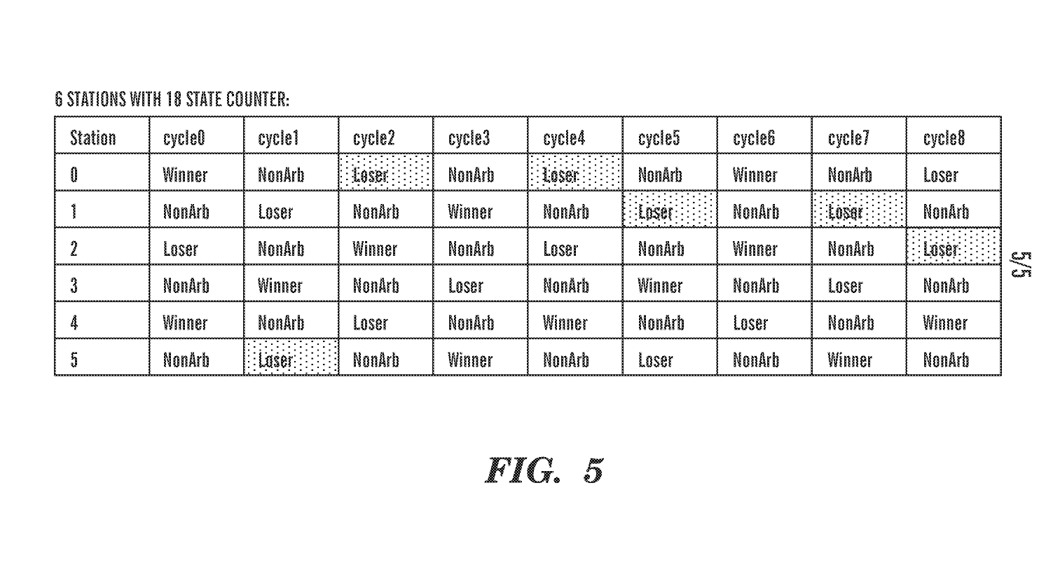

This unfairness can be counteracted by adding more counter states to the winner/loser algorithm. The number of states must be an integer multiple of the number of stations in the ring. For best results, the number of stations in a winner state should be maximized while minimizing cases of back-to-back Loser-Loser or Winner-Winner states, and back-to-back conditions must rotate evenly between stations. In the case of the 6 station ring in FIG. 5, an 18 state counter (9 non-arbitration, 4 winner, and 5 loser states) is used. This analysis can be used to extend the solution for use with other numbers of stations.

The exemplary embodiments allow for the elimination of a centralized arbitration mechanism in a ring topology network. Moreover, the exemplary embodiment of the described distributed arbitration mechanism used in ring networks efficiently uses the rings available bandwidth, reduces latency to access the data ring by the removal of a centralized arbiter and enables multiple and non-colliding transfers of data to occur simultaneously. The embodiment of the arbitration mechanism defines the use of an arbitration cycle, which if successful, is followed by a 2 cycle data transfer (arbitration block). Fairness is assured by the use of a cyclic winner flag where adjacent upstream neighbors are not allowed to consume all the arbitration blocks that appear to be available; instead arbitration blocks are allowed to pass unused for use by its downstream neighbors. In addition, this mechanism allows easy scalability by simply inserting or removing a station from anywhere on the network without requiring re-design of the arbitration scheduling mechanism, which would be required in the case of a centralized arbiter. Finally, the method of the exemplary embodiments is simplifying arbitration logic to the point that stations individually control the processing of their nodes without the delay of continuously checking the arbitration logic before a decision is centrally confirmed.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for employing a scalable distributed arbitration scheme, the system comprising:
a plurality of stations interconnected via a ring topology for transferring data between the plurality of stations; and
a bus coupling the plurality of stations in the ring topology;
wherein each of the plurality of stations on the topology ring is permitted to independently make a decision when to load their data on the topology ring by evaluating a set of inputs.

2. The system of claim 1, wherein the set of inputs is determined by a number of outputs from neighboring stations of a station of the plurality of stations, the neighboring stations being an upstream station and a downstream station.

3. The system of claim 2, wherein the set of inputs are incoming data valids and signals indicating an intent to send the data from the neighboring stations.

4. The system of claim 2, wherein the decision is based on a winner flag state, the winner flag state used to keep the station from locking out the downstream station's access to available arbitration blocks.

5. The system of claim 4, wherein the winner flag state is passed between the plurality of stations.

6. The system of claim 4, wherein the winner flag state is tracked internally by each of the plurality of stations.

7. The system of claim 1, wherein the data transfers are broken into two-beat data transfers.

8. The system of claim 6, wherein the winner and arbitration state is tracked internally using a 2-bit counter when the number of stations is a multiple of 4.

9. The system of claim 6, wherein the winner and arbitration state is tracked internally using an extended set of states when the number of stations is a multiple of 2.

10. A method having a plurality of stations interconnected via a ring topology for passing data between the plurality of stations by a scalable distributed arbitration scheme, the method comprising:
interconnecting a plurality of stations via a ring topology for transferring data between the plurality of stations; and
coupling the plurality of stations in the ring topology via a bus;
wherein each of the plurality of stations on the topology ring is permitted to independently make a decision when to load the data on the topology ring by evaluating a set of inputs.

11. The method of claim 10, wherein the set of inputs is determined by a number of outputs from neighboring stations of a station of the plurality of stations, the neighboring stations being an upstream station and a downstream station.

12. The method of claim 11, wherein the set of inputs are incoming data valids and signals indicating an intent to send the data from the neighboring stations.

13. The method of claim 11, wherein the decision is based on a winner flag state, the winner flag state used to keep the station from locking out the downstream station's access to available arbitration blocks.

14. The method of claim 13, wherein the winner flag is passed between the plurality of stations.

15. The method of claim 13, wherein the winner flag is tracked internally by each of the plurality of stations.

16. The method of claim 10, wherein the data transfers are broken into two-beat data transfers.

17. The method of claim 15, wherein the winner and arbitration state is tracked internally using a 2-bit counter when the number of stations is a multiple of 4.

18. The method of claim 15, wherein the winner and arbitration state is tracked internally using an extended set of states when the number of stations is a multiple of 2.
